(19) United States
(12) Patent Application Publication
(10) Pub. No.: US 2020/0009899 A1
(43) Pub. Date: Jan. 9, 2020

(54) WRITING IMPLEMENT

(71) Applicant: Kotobuki & Co., Ltd., Kawagoe-shi (JP)

(72) Inventor: Tadao ODAKA, Kawagoe-shi, Saitama-ken (JP)

(21) Appl. No.: 16/482,678

(22) PCT Filed: Feb. 21, 2018
(86) PCT No.: PCT/JP2018/006158

§ 371 Date: Jul. 31, 2019

(30) Foreign Application Priority Data
Feb. 22, 2017 (JP) 2017-031086

(51) Int. Cl. B43K 21/16; B43K 21/22

(52) U.S. Cl. CPC B43K 21/16; B43K 21/22

(57) ABSTRACT

A writing implement according to an embodiment includes a position adjustment mechanism for adjusting a set position of a movable member that is capable of moving in an axial direction, wherein the position adjustment mechanism includes a pressing member that presses the movable member from a radial direction.

### FIELD

This disclosure relates to a writing implement having a position adjustment mechanism, with which a set position of a movable member that is capable of moving in an axial direction can be adjusted.

### BACKGROUND

A conventional writing implement includes a position adjustment mechanism with which a user can adjust a set position of a movable member that is capable of moving in an axial direction and constitutes the writing implement. In the position adjustment mechanism of this conventional writing implement, for example, the movable member is screwed to a position adjustment mechanism main body, and respective screw portions of these components are biased in the axial direction by an elastic body such as a coil spring so as to contact each other tightly in order to maintain the set position adjusted by the user.

A mechanical pencil having a sliding sleeve that is screwed to an outside tubular portion and moves freely in a front-rear direction by rotating integrally with a dial sleeve disposed to the rear thereof, an inside tubular portion screwed to the sliding sleeve to be free to rotate, and a front barrel that is screwed to the outside tubular portion to be free to rotate, and that moves freely in the front-rear direction, is available as an example of this type of writing implement having a position adjustment mechanism (see Document 1).

The following is the reference document.

[Document 1] Japanese Patent Application Publication No. 2004-223820 (see claims 1 to 3, paragraphs 0009 and 0019 to 0026, FIG. 3, and so on, for example)

In the position adjustment mechanism of the conventional writing implement disclosed in Document 1, the respective screw portions of the movable member and the position adjustment mechanism main body are biased in the axial direction by the coil spring in order to maintain the adjusted set position of the movable member. In this case, a compression amount of the compressed coil spring may differ according to differences in the positionally adjusted set position of the movable member. Accordingly, when the compression amount of the compressed coil spring increases, an excessively large operating force may be required to make an adjustment by moving the movable member further in the axial direction. Conversely, when the compression amount of the compressed coil spring decreases, it may be impossible to obtain a sufficient biasing force to hold the movable member in the adjusted set position. Hence, a problem exists in this conventional writing implement having a position adjustment mechanism in that a holding force differs according to differences in the adjusted set position of the movable member.

To solve the problem described above, this disclosure provides a writing implement having a position adjustment mechanism with which differences in a holding force corresponding to differences in an adjusted set position of a movable member can be reduced in comparison with the prior art.

### SUMMARY

A writing implement according to an aspect of the present invention includes a position adjustment mechanism for adjusting a set position of a movable member that is capable of moving in an axial direction, wherein the position adjustment mechanism includes a pressing member that presses the movable member from a radial direction.

According to the plurality of embodiments of the present invention, it is possible to provide a writing implement having a position adjustment mechanism with which differences in a holding force corresponding to differences in an adjusted set position of a movable member can be reduced in comparison with the prior art.

### BRIEF DESCRIPTION OF DRAWINGS

FIG. 1 is a sectional view illustrating a mechanical pencil serving as a writing implement according to an embodiment of the present invention, taken on a plane that includes a central axis of the mechanical pencil;

FIG. 2 is an assembly process diagram illustrating an assembly process of the mechanical pencil according to the embodiment from the side;

FIG. 3 is a view illustrating a writing lead chucking/feeding out mechanism of the mechanical pencil according to the embodiment from the side;

FIG. 4 is a partially enlarged sectional view illustrating a partial enlargement of the writing lead chucking/feeding out mechanism illustrated in FIG. 3, taken on a plane that includes a central axis thereof;

FIG. 5 is a sectional view illustrating a rear barrel of the mechanical pencil according to the embodiment, taken on a plane that includes a central axis thereof;

FIG. 6 is a sectional view illustrating the rear barrel of FIG. 5 from the front, taken on an orthogonal plane to the central axis thereof;

FIG. 7 is a view illustrating a front barrel of the mechanical pencil according to the embodiment from the side;

FIG. 8 is a sectional view illustrating the front barrel of FIG. 7, taken on a plane that includes a central axis thereof;

FIG. 9 is a view illustrating a front piece serving as a movable member of the mechanical pencil according to the embodiment from the side; and

FIG. 10 is a sectional view illustrating the front piece of FIG. 9, taken on a plane that includes a central axis thereof.

### DESCRIPTION OF EMBODIMENTS

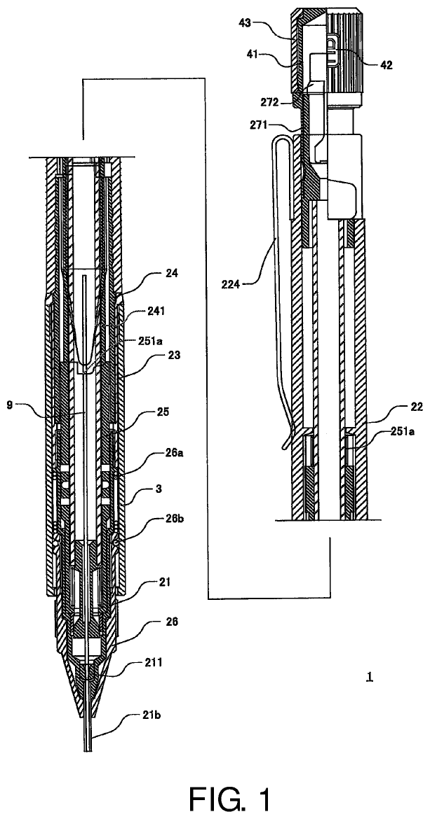

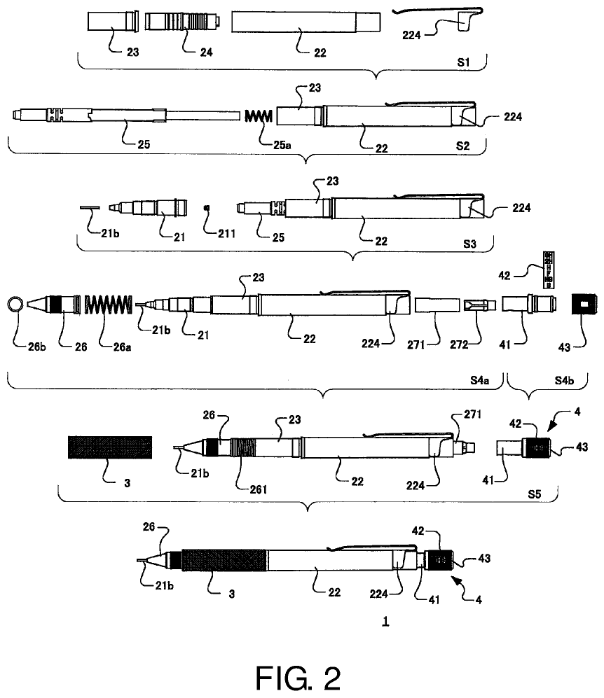

An embodiment of the present invention will be described below with reference to the figures. First, a configuration of a mechanical pencil serving as a writing implement according to this embodiment will be described together with an assembly process thereof. In the following description, an extension direction of a central axis of the mechanical pencil (a lengthwise direction of the mechanical pencil, which is formed in a columnar shape) will be referred to as a central axis direction (or simply “the axial direction”), an end portion of the axial direction from which a writing lead is fed out will be referred to as a front end of the mechanical pencil, and an end portion on an opposite side thereto will be referred to as a rear end of the mechanical pencil. FIG. 1 is a sectional view illustrating a mechanical pencil 1 according to this embodiment from the side, taken on a plane that includes the central axis thereof. The rear portion of the mechanical pencil 1 is illustrated from the side. FIG. 2 is an assembly process diagram illustrating an assembly process of the mechanical pencil 1 according to this embodiment from the side.

As shown in FIGS. 1 and 2, the mechanical pencil 1 includes a front barrel 21, a packing (a writing lead holder) 211, a front tip pipe 21b, a rear barrel 22, an inner barrel 23, a fitting tube 24, a writing lead chucking/feeding out mechanism 25, a cushion spring 25a, a front piece 26, a screw portion pressing spring 26a, an eraser receptacle 271, an eraser 272, an outer barrel 3, and a clicking unit 4. Each of these constituent components will be described in detail below.

The rear barrel 22, the inner barrel 23, and the fitting tube 24 are all substantially tubular members, and these members, together with the front barrel 21 and the outer barrel 3, to be described in detail below, constitute a barrel assembly of the mechanical pencil 1. As illustrated in S1 of FIG. 2, the fitting tube 24 is connected to the rear barrel 22 to be capable of rotating relative thereto by press-fitting a rear end portion of the fitting tube 24 into the rear barrel 22 from a front end side thereof. Further, the fitting tube 24 is connected to the inner barrel 23 to be capable of rotating integrally therewith by press-fitting a front end portion of the fitting tube 24 into the inner barrel 23 from a rear end side thereof. As a result, the rear barrel 22 and the inner barrel 23 can rotate relative to each other. An attachment portion of a clip 224 is fitted onto an outer peripheral surface of a rear end portion of the rear barrel 22, whereby the clip 224 is attached to the rear barrel 22. A pair of cams 241 disposed at 180° intervals in a circumferential direction are formed on an inner peripheral surface of the fitting tube 24 so as to project radially inward from the inner peripheral surface. Each of the cams 241 has a cam front end shaped to project toward the front end side, and the cam front end contacts a cam surface formed on a sleeve 251, to be described in detail below, so as to follow the cam surface. Adjustment of a cushioning stroke realized by the cam 241 and the cam surface formed on the sleeve 251 will be described in detail below.

The writing lead chucking/feeding out mechanism 25 is capable of chucking a writing lead 9 formed from thin, elongated graphite to enable writing, and capable of feeding the writing lead 9 forward in response to a clicking operation executed by a user. As illustrated in S2, the writing lead chucking/feeding out mechanism 25 is inserted into a rear barrel assembly constituted by the rear barrel 22, the inner barrel 23, and the fitting tube 24 from a front end side thereof in a condition where the cushion spring 25a, which is formed from a compression coil spring, is mounted on a rear portion outer periphery thereof. The cushion spring 25a is compressed in the axial direction between the rear barrel 22 and the writing lead chucking/feeding out mechanism 25 so as to bias the writing lead chucking/feeding out mechanism 25 frontward by a predetermined load. A cushioning mechanism of the mechanical pencil 1 having the cushion spring 25a is a mechanism for alleviating excessive writing pressure exerted on the writing lead 9 during writing by biasing the writing lead chucking/feeding out mechanism 25 frontward so as to be capable of retreating. As will be described in detail below, with the cushioning mechanism of the mechanical pencil 1 according to this embodiment, the magnitude by which the writing pressure is alleviated can be adjusted by making a distance (the cushioning stroke) by which the writing lead chucking/feeding out mechanism 25 can retreat adjustable from zero (no alleviation) to a predetermined amount.

As illustrated in S3, the front barrel 21 is formed in a substantially tubular shape having a tapered front end side, and the packing 211, which has a central aperture for clamping the fed writing lead 9 by a predetermined pressure, is incorporated into a front end thereof. A front tip pipe 21b for guiding the writing lead 9 is press-fitted fixedly into the front end of the front barrel 21 so as to project by a predetermined amount. A screw portion 210b is formed on a rear end portion outer periphery of the front barrel 21, and in a condition where the front barrel 21 covers a front end portion of the writing lead chucking/feeding out mechanism 25, the screw portion 210b of the front barrel 21 is screwed to a corresponding screw portion formed on a front end portion inner periphery of the inner barrel 23.

The front piece 26, which serves as the movable member of the mechanical pencil 1 according to this embodiment, is configured to be capable of moving in the axial direction so that the user can adjust the amount by which the front tip pipe 21b projects from the front end of the front piece 26 as desired. As illustrated in S4a, the front piece 26 is formed in a substantially tubular shape having a tapered front end side, and as illustrated in FIG. 10, a screw portion 260b is formed on a rear end portion inner periphery thereof. In a condition where the screw portion pressing spring 26a, which is constituted by a compression coil spring, is mounted on the outer periphery of the front barrel 21, the screw portion 260b of the front piece 26 is screwed to a screw portion 211a (see FIG. 7) formed on an outer peripheral surface of the front barrel 21 such that the front piece 26 covers the outer periphery of the front end portion of the front barrel 21. The front tip pipe 21b press-fitted fixedly into the front end portion of the front barrel 21 is capable of projecting from and retracting into an opening formed in the front end of the front piece 26. Hence, as will be described below, the user can adjust the length by which the front tip pipe 21b projects from the front end of the front piece 26 by adjusting a set position of the front piece 26 relative to the front barrel 21. An elastomer O-ring 26b formed in an annular shape is attached to an outer periphery of the front piece 26. As will be described in detail below, the O-ring 26b is attached between the front piece 26 and the outer barrel 3, and configured to press the front piece 26 inward in a radial direction. The O-ring 26b may be formed from any arbitrary material that is sufficiently elastic to be capable of pressing the front piece 26 in the radial direction.

The eraser receptacle 271 is formed in a substantially tubular shape, and as illustrated in S4a, the eraser 272 is inserted into a rear portion thereof, while a front portion thereof is inserted into a rear end portion of the rear barrel 22 and attached to a rear end of the writing lead chucking/feeding out mechanism 25. An outer diameter of the rear portion of the eraser receptacle 271 is formed to be smaller than an inner diameter of the rear portion of the rear barrel 22 so that a gap for incorporating a click bar 41 is formed between an inner peripheral surface of the rear barrel 22 and an outer peripheral surface of the eraser receptacle 271.

As illustrated in S4b, the clicking unit 4 includes the click bar 41, which is formed in a substantially tubular shape, a hardness indicator 42 for indicating a hardness of the writing lead 9, as selected by the user, and an indicator ring 43 that has an opening in one location on a side face thereof, through which the user can see a selected part of the hardness indicator 42, and is formed in a substantially tubular shape having a closed rear end surface to be fitted to a rear end portion of the click bar 41. By rotating the indicator ring 43 fitted onto the rear end portion of the click bar 41 in the circumferential direction, the user can selectively expose to the outside a selected hardness indicator of the writing lead 9, which is written on the hardness indicator 42 adhered to the rear portion of the click bar 41, so that the exposed hardness indicator is displayed.

As illustrated in S5, the outer barrel 3 is a member formed in a substantially tubular shape and mounted on the respective outer peripheries of the front piece 26 and the inner barrel 23. An outer peripheral surface of the outer barrel 3 is knurled so that the user can grip the barrel more easily. A screw portion is formed on a rear end portion inner peripheral surface of the outer barrel 3, and in a condition where the outer barrel 3 covers the front barrel 21, the rear portion of the front piece 26, and the outer periphery of the inner barrel 23, the screw portion on the rear end portion inner peripheral surface of the outer barrel 3 is screwed to a screw portion formed on the rear portion outer peripheral surface of the inner barrel 23. The outer barrel 3 and the rear barrel 22 screwed integrally to the inner barrel 23 are capable of rotating relative to each other in order to facilitate an operation for adjusting the cushioning stroke, to be described in detail below. The click bar 41 of the clicking unit 4 is attached detachably to a rear portion outer peripheral surface of the eraser receptacle 271 protruding from the rear end of the rear barrel 22. When the clicking unit 4 is detached, the eraser 272 mounted in the eraser receptacle 271 can be used.

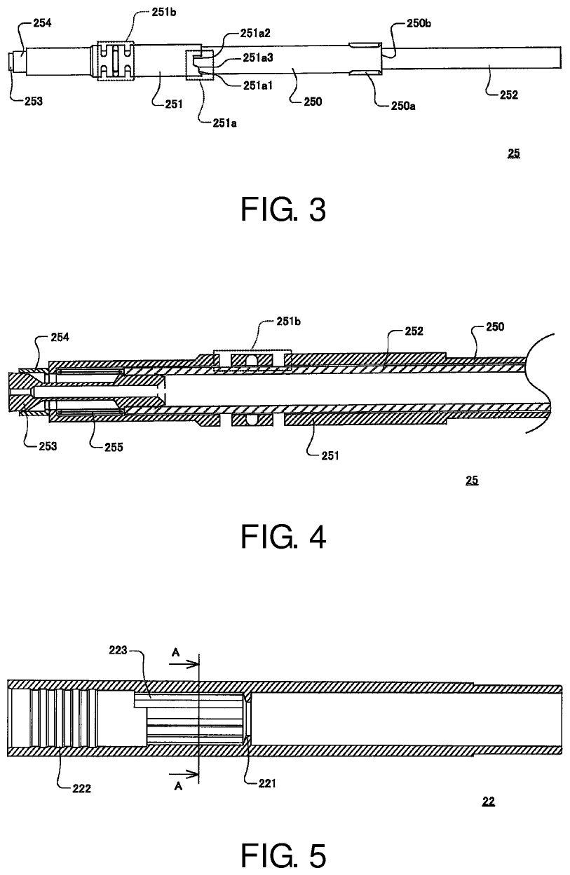

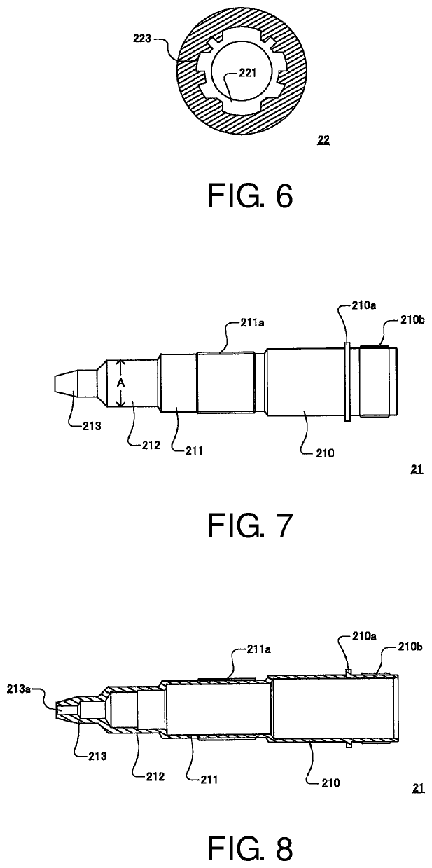

Next, respective configurations of the writing lead chucking/feeding out mechanism and the rear barrel will be described. FIG. 3 is a view illustrating the writing lead chucking/feeding out mechanism from the side. FIG. 4 is an enlarged sectional view illustrating an enlargement of the writing lead chucking/feeding out mechanism illustrated in FIG. 3, taken on a plane that includes a central axis thereof. FIG. 5 is a sectional view illustrating the rear barrel, taken on a plane that includes a central axis thereof. FIG. 6 is a sectional view illustrating the rear barrel according to this embodiment from the front, taken on an orthogonal plane to the central axis thereof.

As illustrated in FIGS. 3 and 4, the writing lead chucking/feeding out mechanism 25 includes a central portion 250 formed in a tubular shape, a sleeve 251 formed integrally with the central portion 250 but having a larger outer diameter than the central portion 250, a writing lead pipe 252 mounted in the interior of the central portion 250 in order to house the writing lead 9, a chuck 253 capable of chucking the writing lead 9 and feeding the writing lead 9 forward, a chuck ring 254 mounted on the chuck 253, and a chuck spring 255 constituted by a compression coil spring and housed in the sleeve 251.

The chuck spring 255 biases the writing lead pipe 252, into which a rear end portion of the chuck 253 is press-fitted, rearward against the sleeve 251. Thus, a front end portion of the chuck 253 is fitted to the chuck ring 254 such that the chuck ring 254 is sandwiched between the front end portion of the chuck 253 and a front end surface of the sleeve 251, whereby the chuck 253 is pressed radially inward by the front end portion of the chuck ring 254 fitted thereto so as to chuck the writing lead 9. When the user of the mechanical pencil 1 performs an operation to click the clicking unit 4 forward, the writing lead chucking/feeding out mechanism 25 is fed forward while chucking the writing lead 9. When the writing lead chucking/feeding out mechanism 25 advances to a predetermined position, the chuck ring 254 contacts the barrel such that the chuck 253 moves forward relative to the chuck ring 254 against the biasing force of the chuck spring 255, whereby the fit between the chuck 253 and the chuck ring 254 is released, and as a result, the chuck on the writing lead 9 is released. When the user terminates the operation to click the clicking unit 4, the writing lead 9 remains clamped by the packing (the writing lead holder) 211 so as to be held in the fed position, and the chuck 253 and chuck ring 254 are caused to retreat by the biasing force of the chuck spring 255 while leaving the writing lead 9 fed forward. As a result, the chuck 253 and the chuck ring 254 chuck the writing lead 9 in a position further rearward than before.

The sleeve 251 includes meshing portions 251a constituting the cushioning mechanism with which the cushioning stroke of the mechanical pencil 1 according to this embodiment can be adjusted, and an incorporation error absorption portion 251b for eliminating an axial direction incorporation error relative to a barrel of the central portion 250 and the sleeve 251. Cushioning stroke adjustment by the cushioning mechanism of the mechanical pencil 1 according to this embodiment will now be described.

The pair of meshing portions 251a are formed on a rear end surface of the sleeve 251 at 180° intervals in the circumferential direction. The pair of meshing portions 251a of the sleeve 251 are formed to respectively oppose the pair of cams 241 (see FIG. 1) formed on the inner peripheral surface of the fitting tube 24. Each of the meshing portions 251a constitutes the cam surface opposing the cam 241, and includes a first part 251a1 serving as a rear cam surface, a second part 251a2 serving as a front cam surface, and a third part 251a3 serving as an intermediate cam surface positioned between the first part 251a1 and the second part 251a2 so as to connect the first part 251a1 and the second part 251a2.

An engagement portion 250a that projects radially outward and is engaged to the inner peripheral surface of the rear barrel 22 is formed on a rear end of the central portion 250 of the writing lead chucking/feeding out mechanism 25, and as will be described in detail below, when the writing lead chucking/feeding out mechanism 25 is incorporated into the rear barrel 22, the rear barrel 22 and the writing lead chucking/feeding out mechanism 25 rotate integrally. Hence, the writing lead chucking/feeding out mechanism 25 is configured such that when the rear barrel 22 is rotated relative to the inner barrel 23 and the fitting tube 24, the writing lead chucking/feeding out mechanism 25 is capable of rotating together with the rear barrel 22 relative to the inner barrel 23 and the fitting tube 24 having the cams 241 formed on the inner peripheral surface thereof. Thus, the circumferential direction position in which the front end of the cam 241 contacts the meshing portion 251a can be modified, and accordingly, the axial direction position of the front end of the cam 241 relative to the meshing portion 251a can be modified. As a result, the cushioning stroke, i.e. an operating stroke of the cushion spring 25a that performs a cushioning operation while compressed in the axial direction between a latch portion 250b provided on a rear end of the central portion 250 and the rear barrel 22, can be modified.

In this embodiment, when the front end of the cam 241 contacts the first part 251a1 of the meshing portion 251a, the cushioning stroke is zero. In this case, the cushion spring 25a does not undergo compression deformation. When the front end of the cam 241 contacts the second part 251a2 of the meshing portion 251a, on the other hand, the cushioning stroke reaches a maximum such that the cushion spring 25a is capable of compression deformation by the permitted cushioning stroke. When the front end of the cam 241 contacts the third part 251a3 of the meshing portion 251a, a cushioning stroke is performed at an intermediate cushioning stroke between zero and the maximum. Hence, in this embodiment, the user can adjust the cushioning stroke as desired.

Referring to FIGS. 5 and 6, the rear barrel 22 will be described further. The rear barrel 22 includes a latch portion 221 that is formed to project radially inward around the entire periphery of an inner peripheral surface thereof in order to latch a rear end portion of the cushion spring 25a. A connecting portion 222 constituted by a plurality of annular grooves extending in the circumferential direction is formed on the inner peripheral surface of the front portion of the rear barrel 22 in order to engage the fitting tube 24 so that the fitting tube 24 can rotate relative thereto. Further, an engaged portion 223 constituted by a plurality of grooves that extend in the axial direction and are engaged to the engagement portion 250a of the writing lead chucking/feeding out mechanism 25 so that the writing lead chucking/feeding out mechanism 25 and the rear barrel 22 rotate integrally is formed on the inner peripheral surface of the rear barrel 22.

In this embodiment, the user can adjust the position in which the front end of the cam 241 contacts the meshing portion 251a by rotating the outer barrel 3 screwed to the inner barrel 23 relative to the rear barrel 22, and in so doing, the user can adjust the distance (the cushioning stroke) by which the writing lead chucking/feeding out mechanism 25 is capable of retreating. Therefore, the user of the mechanical pencil 1 can adjust a maximum load (a cushioning operation load) of the writing pressure exerted on the writing lead 9 in accordance with the hardness of the writing lead 9, the material of a paper surface, and so on.

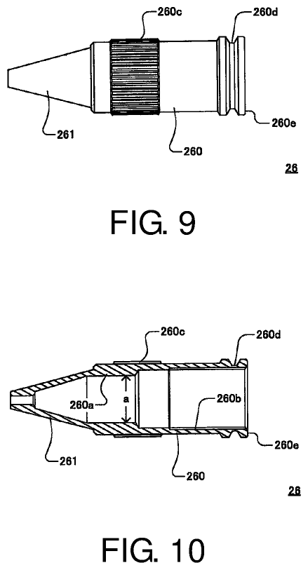

Referring to FIGS. 7 to 9, the respective configurations of the front barrel 21 and the front piece 26 will be described further. FIG. 7 is a view illustrating the front barrel 21 according to this embodiment from the side. FIG. 8 is a sectional view illustrating the front barrel 21 of FIG. 7, taken on a plane that includes a central axis thereof. FIG. 9 is a view illustrating the front piece 26 according to this embodiment from the side. FIG. 10 is a sectional view illustrating the front piece 26 of FIG. 9, taken on a plane that includes a central axis thereof.

As illustrated in FIGS. 7 and 8, the front barrel 21 is formed in a substantially tubular shape having a plurality of parts with different outer diameters. The plurality of parts of the front barrel 21 can be broadly divided into a first diameter portion 210, a second diameter portion 211, a third diameter portion 212, and a fourth diameter portion 213, in order from the rear end side. The first diameter portion 210 is formed to have the largest outer diameter of the front barrel 21, and an outer peripheral surface thereof includes a flange 210a that projects radially outward around the entire periphery in order to latch a rear end portion of the screw portion pressing spring 26a. The screw portion 210b for screwing the outer peripheral surface of the front barrel 21 to the inner peripheral surface of the inner barrel 23 is formed on the outer peripheral surface of the first diameter portion 210 to the rear of the flange 210a. The second diameter portion 211 is formed to have a smaller outer diameter than the first diameter portion 210, and the screw portion 211a for screwing the outer peripheral surface of the front barrel 21 to the inner peripheral surface of the front piece 26 is formed on an outer peripheral surface thereof. The third diameter portion 212 is formed to have an outer diameter dimension “A”, to be described in detail below, which is smaller than the outer diameter of the second diameter portion 211. The fourth diameter portion 213 is formed to have the smallest outer diameter of the front barrel 21 and a tapered front end, and a aperture 213a into which the front tip pipe 21b can be press-fitted is formed in a front end thereof.

As illustrated in FIGS. 9 and 10, the front piece 26 includes, in order from the rear end side thereof, a trunk portion 260 formed in a substantially tubular shape, and a conical portion 261 formed in a substantially conical tubular shape. The conical portion 261 has a through hole in a front end thereof, through which the front tip pipe 21b of the front barrel 21 projects and retracts. The screw portion 260b is formed on an inner peripheral surface of the trunk portion 260, and screwed to the screw portion 211a on the outer peripheral surface of the second diameter portion 211 of the front barrel 21. Further, an interior space 260a is formed in the front piece 26 so that when the front piece 26 is set maximally rearward relative to the front barrel 21, the inner peripheral surface of the front piece 26 approaches or contacts the outer peripheral surface of the front barrel 21 in the axial direction and the radial direction. An inner diameter “a” of the interior space 260a formed in the front piece 26 frontward of the trunk portion 260 is set in accordance with the outer diameter “A” (see FIG. 7) of the third diameter portion 212 of the front barrel 21 so that contact is substantially established therebetween. A knurled gripping portion 260c for facilitating an operation performed by the user to rotate the front piece 26 in the circumferential direction is formed on an outer peripheral surface of the trunk portion 260 of the front piece 26 so as to extend around the entire periphery thereof.

A mounting groove 260d for mounting the O-ring 26b (see FIGS. 1 and 2) is formed in the outer peripheral surface of the rear end portion of the front piece 26 so as to extend around the entire periphery thereof. Front and rear walls of the mounting groove 260d are formed as inclined surfaces inclined such that a groove width increases radially outward. According to this configuration, a pressing force exerted by the O-ring 26b mounted on the front piece 26 to press the front piece 26 radially inward can be dispersed to the front and rear walls of the mounting groove 260d, and equilibrium can be achieved in the dispersed pressing force. Hence, the O-ring 26b can be brought into contact with the outer peripheral surface of the front piece 26 such that a plurality of contact portions are formed, and the pressing force exerted by each of the plurality of contact portions can be made uniform. As a result, a highly reliable contact condition can be obtained, and excessive stress on the O-ring 26b can be avoided so that the O-ring 26b can be used for a longer time.

In this embodiment, the front barrel 21, the front piece 26, the screw portion pressing spring 26a, and the O-ring 26b together constitute an adjustment mechanism capable of adjusting the amount by which the front tip pipe 21b of the front barrel 21 projects from the front end of the front piece 26. The user can operate the front piece 26 screwed to the front barrel 21 by gripping the gripping portion 260c of the front piece 26 and rotating the gripping portion 260c relative to the front barrel 21 about the central axis. By performing this adjustment operation, the relative axial direction set position of the front piece 26 relative to the front barrel 21 can be adjusted while maintaining the screw fastening between the front barrel 21 and the front piece 26. By means of this adjustment, the front tip pipe 21b fixed to the front end of the front barrel 21 can be adjusted so as to project from the front end of the front piece 26 by an amount desired by the user, or so as to be housed completely inside the front piece 26. The adjusted position of the front piece 26, adjusted by the user, is maintained by the O-ring 26b, which contacts and presses the front piece 26 around the entire periphery thereof from the radial direction outer side. A holding force by which the O-ring 26b holds the front piece 26 in the predetermined adjustment position does not differ according to differences in the adjusted position of the front piece 26.

Further, in this embodiment, the respective screw portions of the front barrel 21 and the front piece 26 are biased by the screw portion pressing spring 26a such that the front barrel 21 and the front piece 26 are separated from each other in the axial direction. By pressing the screw portions of the front barrel 21 and the front piece 26 in the axial direction using the screw portion pressing spring 26a, a screw thread on the screw portion 211a of the front barrel 21 and a screw thread on the screw portion 260b of the front piece 26 contact each other tightly such that a frictional force on a contact surface between the screw portions can be increased. The magnitude of the pressing force applied in the axial direction by the screw portion pressing spring 26a according to this embodiment is set such that the user cannot sense differences in a rotation operation force applied to the front piece 26 corresponding to differences in the adjusted position of the front piece 26. According to this configuration, the holding force for holding the front piece 26 in the adjusted position can be increased further. Alternatively, in a case where compressive stress exerted on the O-ring 26b is reduced in accordance with the increase in the holding force, the O-ring 26b can be used for an even longer time. In another embodiment, the screw portion pressing spring 26a may be configured to bias the front barrel 21 and the front piece 26 toward each other in the axial direction. Likewise in this case, the respective screw portions of the front barrel 21 and the front piece 26 can be pressed. The screw portion pressing spring 26a may bias the front barrel 21 and the front piece 26 in any manner as long as the screw thread on the screw portion 211a of the front barrel 21 and the screw thread on the screw portion 260b of the front piece 26 contact each other tightly.

When the O-ring 26b, which is formed from an elastomer material, is attached to the front piece 26 so as to project to the radial direction outer side of the front piece 26 and configured to press the front piece 26 in the radial direction, as in this embodiment, frictional force can be generated in the circumferential direction against the rotation of the front piece 26 while the O-ring 26b contacts the inner peripheral surface of the outer barrel 3 due to the O-ring 26b having a comparatively high frictional coefficient in comparison with other materials. As a result, the front tip pipe 21b can be held in the adjusted position with even greater stability.

In the embodiment, the amount by which the front tip pipe 21b of the mechanical pencil 1 projects from the front piece 26 is adjusted, but in another embodiment, the configurations may be applied similarly to another adjustment mechanism for adjusting the axial direction set position of a movable member of another writing implement, such as an amount by which a tip of a ball pen projects from a nose cone, for example. Further, a pressing member, which in the embodiment is exemplified by the O-ring 26b, may be any member that presses the movable member in the radial direction, and the pressing member may press the movable member either radially inward or radially outward.

The embodiments are cited as examples, and are not intended to limit the scope of the present invention. These novel embodiments may be implemented in various other forms, and various omissions, replacements, and modifications may be executed thereon within a scope that does not depart from the spirit of the invention. The embodiments and modifications thereof are included within the scope and spirit of the invention, and included within the scope of the claims and the scope of equivalents thereto.

### REFERENCE SIGNS LIST

1 Writing implement
21 Front barrel
25 Writing lead chucking/feeding out mechanism
26 Front piece
26b O-ring

What is claimed is:

1. A writing implement including a position adjustment mechanism for adjusting a set position of a movable member that is capable of moving in an axial direction,
wherein the position adjustment mechanism includes a pressing member that presses the movable member from a radial direction.

2. The writing implement according to claim 1, wherein the pressing member is formed in an annular shape from an elastomer material, and an inner peripheral surface or an outer peripheral surface thereof contacts the movable member so as to press the movable member in the radial direction.

3. The writing implement according to claim 2, wherein a groove in which the pressing member is mounted is formed to extend around an entire periphery in a circumferential direction, and front and rear walls of the groove are formed as inclined surfaces inclined such that a groove width increases toward a radial direction outer side.

4. The writing implement according to claim 1, wherein the movable member is screwed to the position adjustment mechanism, and the writing implement further includes a screw portion pressing spring for biasing a screw portion of the screw fastening in an axial direction.

5. The writing implement according to claim 1, further including:
a writing lead chucking/feeding out mechanism capable of chucking and feeding out a writing lead;
first and second barrels housing the writing lead chucking/feeding out mechanism, and rotating relative to each other; and
a cushion spring for biasing the writing lead chucking/feeding out mechanism toward a front end side, wherein
one of the first and second barrels includes a cam that projects toward the other,
the other of the first and second barrels includes a cam surface that opposes the cam in an axial direction, and
the cam surface includes a first part in which an amount by which the cushion spring can move is zero, a second part in which the amount by which the cushion spring can move is a maximum amount, and a third part formed as an intermediate part connecting the first part and the second part.
